(19) United States
(12) Patent Application Publication
(10) Pub. No.: US 2014/0235253 A1
(43) Pub. Date: Aug. 21, 2014

(54) CALL ROUTING AMONG PERSONAL DEVICES BASED ON VISUAL CLUES

(71) Applicants: Hong C. Li, El Dorado Hills, CA (US); Rita H. Wouhaybi, Portland, OR (US)

(72) Inventors: Hong C. Li, El Dorado Hills, CA (US); Rita H. Wouhaybi, Portland, OR (US)

(21) Appl. No.: 13/772,626

(22) Filed: Feb. 21, 2013

(51) Int. Cl. H04W 40/02

(52) U.S. Cl. CPC H04W 40/02
USPC 455/445

(57) ABSTRACT

Systems and methods may provide for identifying a plurality of devices and routing a call between a first device in the plurality of devices and a second device in the plurality of devices. The routing of the call may be in response to a visual condition with respect to a user of the first device. In one example, the visual condition is detected based on image data associated with a surrounding environment and the visual condition is one or more of a gaze of the user and a gesture of the user.

### TECHNICAL FIELD

Embodiments generally relate to communication device management. More particularly, embodiments relate to call routing among personal devices based on visual clues.

### BACKGROUND

Individuals may use multiple different devices to place and receive calls. For example, in a given setting, a landline phone, wireless smartphone and computing device may all be within reach of an individual, wherein an incoming call might cause one or more of the devices to ring. Manually reaching for and operating the ringing device may be time consuming and inconvenient for the individual, particularly if he or she is wearing a headset connected to a non-ringing device (e.g., listening to music, watching a video), typing on the non-ringing device (e.g., notebook computer), operating a touch screen of the non-ringing device (e.g., smart tablet), and so forth.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of a scenario in which calls are routed among personal devices based on visual clues according to an embodiment;

FIG. 2A is a block diagram of an example a multi-device architecture in which a notebook computer is used to re-route calls according to an embodiment;

FIG. 2B is a block diagram of an example of a multi-device architecture in which a wireless phone is used to re-route calls according to an embodiment;

FIG. 3 is a flowchart of an example of a method of re-routing incoming calls according to an embodiment;

FIG. 4 is a flowchart of an example of a method of re-routing outgoing calls according to an embodiment;

FIG. 5 is a block diagram of an example of a processor according to an embodiment; and

FIG. 6 is a block diagram of an example of a system according to an embodiment.

### DESCRIPTION OF EMBODIMENTS

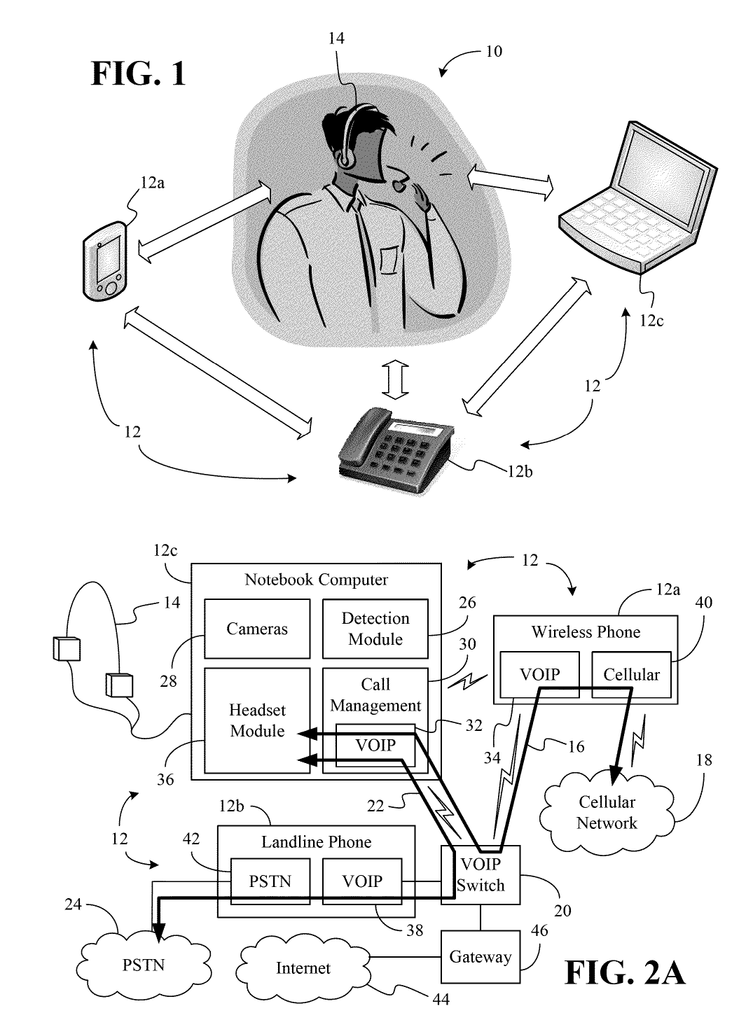

Turning now to FIG. 1, a scenario is shown in which an individual 10 (e.g., user) is associated with a plurality of devices 12 (12a-12c) that may be used to place and receive voice and/or video calls. For example, a wireless phone 12a may be used to place and receive cellular (e.g., Wideband Code Division Multiple Access/W-CDMA (Universal Mobile Telecommunications System/UMTS), CDMA2000 (IS-856/IS-2000), Global System for Mobile Communications (GSM), etc.) calls, voice over Internet protocol (VOIP, e.g., Skype, FaceTime) calls, etc., a landline phone 12b (e.g., desk phone) may be used to place and receive public switched telephone network (PSTN) calls, VOIP calls, etc., a computing device 12c (e.g., notebook computer, Ultrabook™, smart tablet, convertible tablet, etc.) may be used to place and receive VOIP calls, and so forth. As will be discussed in greater detail, visual conditions (e.g., clues) such as the gaze (e.g., eye focus) of the individual 10, gestures made by the individual 10, and so forth, may be used to re-route incoming and outgoing calls.

For example, if the individual 10 is typing on the computing device 12c while listening to music streamed via a Bluetooth (e.g., Institute of Electrical and Electronics Engineers/IEEE 802.15.1-2005, Wireless Personal Area Networks) connection from the computing device 12c to a headset 14 worn by the individual, and an incoming call is received at the wireless phone 12a (e.g., from the cellular network), the individual 10 may cause the incoming call to be re-routed from the wireless phone 12a through the computing device 12c and to the headset 14 by simply looking at the wireless phone 12a, making a motion/gesture towards the wireless phone 12a, etc. In this regard, the computing device 12c may include one or more cameras and a detection module to automatically identify the visual clue/condition. The cameras may also be integral to one of the other devices 12 and/or external to the devices 12 (e.g., part of a surveillance system or other image capture configuration). As a result, any need for the individual 10 to manually reach for, pick up, unlock, answer or otherwise operate the wireless phone 12a may be obviated.

Similarly, if an incoming call is received at the landline phone 12b (e.g., from the PSTN), the individual 10 may cause the incoming call to be re-routed from the landline phone 12b through the computing device 12c and to the headset by looking at the landline phone 12b, making a motion/gesture towards the landline phone 12b, and so forth. Indeed, the individual 10 may also be operating the wireless phone 12a and use visual clues/conditions to re-route incoming calls from the landline phone 12b and/or the computing device 12c to the wireless phone 12a. Incoming calls may be re-routed from the wireless phone 12a and/or the computing device 12c to the landline phone 12b in a similar fashion. Such an approach may significantly reduce the inconvenience experienced by the individual with respect to receiving calls.

Additionally, if the individual 10 is operating the computing device 12c and would like to place an outgoing call via the wireless phone 12a, the individual 10 may issue an outgoing call request by entering a command on the computing device 12c, selecting a menu option on the computing device 12c, and/or making a motion/gesture that may be recognized by the detection module on the computing device 12c as an outgoing call request. The individual 10 may also make a motion/gesture towards the wireless phone 12a to indicate the wireless phone 12a as the device to be used to place the call (e.g., via the cellular network). Similarly, if the individual 10 would like to place an outgoing call via the landline phone 12b, the individual 10 may provide a visual clue to indicate that the landline phone 12b is to be used to place the call even though the individual 10 continues to operate the computing device 12a. Accordingly, an enhanced user experience may be achieved with regard to outgoing calls as well as incoming calls.

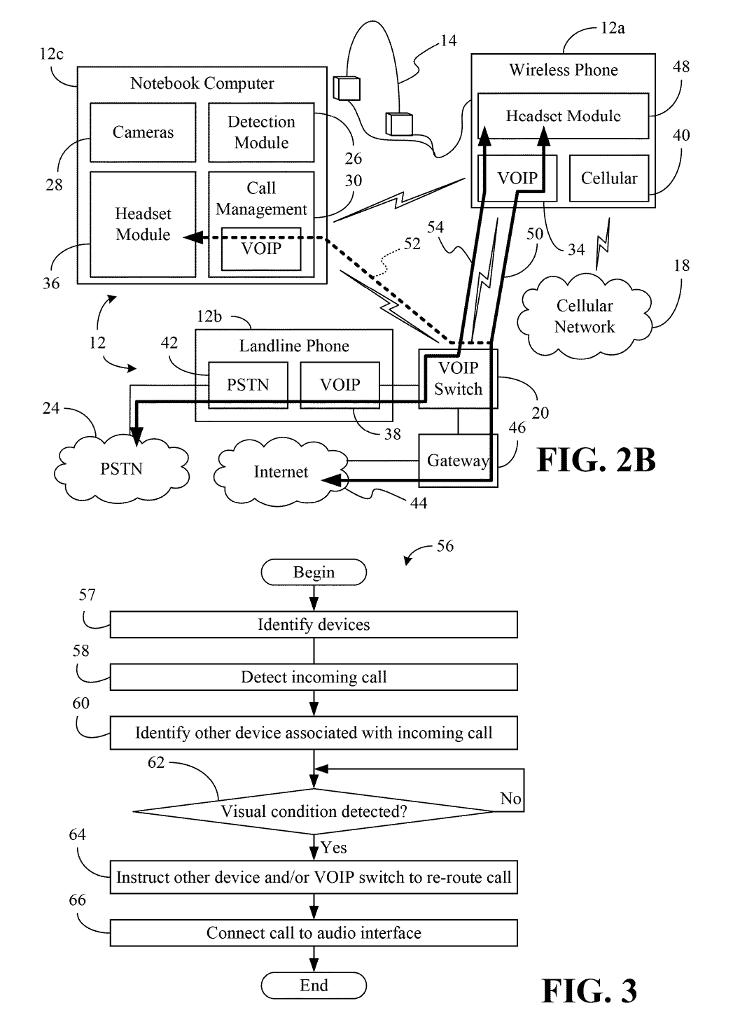

FIG. 2A shows a multi-device architecture in which the computing device 12c (e.g., a notebook computer) is used to re-route calls (e.g., incoming, outgoing, pre-existing) based on visual conditions and/or clues with respect to a user of the computing device 12c. In general, a first call path 16 may be established with respect to the wireless phone 12a so that incoming and/or pre-existing calls from a cellular network 18 (e.g., CDMA, GSM, etc.) are routed through the wireless phone 12a, a VOIP switch 20 and the computing device 12c, and to the headset 14 via a headset module 36. More particularly, the headset module 36 of the computing device 12c may identify a headset connection to the computing device 12c, wherein a call management module 30 may detect an incoming call associated with the wireless phone 12a, instruct the VOIP switch 20 and the wireless phone 12a to route the incoming call to the computing device 12c, and connect the incoming call to the headset 14. The same functionality may be implemented for pre-existing calls. As will be discussed in greater detail, detection of the incoming call may be based on a sound signal associated with the surrounding/ambient environment and/or a notification from the wireless phone 12a.

The first call path 16 may also be used to place and conduct outgoing calls from the computing device 12c to the cellular network 18. In such a case, the call management module 30 may detect an outgoing call request based on the visual condition and/or other user input, initiate an outgoing call via the wireless phone 12a in response to the outgoing call request, and route the outgoing call from the headset 14 to the wireless phone 12a. Thus, the call management module 30 may include call switching and routing functionality that enables incoming, pre-existing and outgoing calls to be handled by other devices in the architecture.

Additionally, a second call path 22 may be established with respect to the landline phone 12b so that incoming calls from a PSTN 24 are routed through the landline phone 12b, the VOIP switch 20 and the computing device 12c, and to the headset 14 via the headset module 36. Outgoing calls may also use the second call path 22 in response to a visual indication from the user that the call should be placed on the PSTN via the landline phone 12b. The landline phone 12b (or another phone) may alternatively have a direct connection to a gateway 46 (e.g., a modem or other suitable networking device) that bypasses the VOIP switch 20 and provides connectivity to a network such as the Internet 44. In such a case, the landline phone 12b and/or the gateway 46 may include call switching and routing functionality that enables calls to be handled by other devices in the architecture. Technologies such as, for example, Microsoft Lync, Cisco VOIP, etc., may be used to facilitate the call switching and routing functionality described herein.

While the illustrated connection between the headset 14 and the computing device 12c is wired, the connection may also be wireless (e.g., Bluetooth, near field communications/NFC, etc.). Moreover, another audio interface component of the computing device 12c such as, for example, integrated speakers, integrated microphone, etc., may be used to conduct and participate in calls rather than the headphones 14.

Of particular note is that the computing device 12c may include a detection module 26 to identify the devices 12, wherein image data from one or more cameras 28 may be used to conduct the identification. The cameras 28 may therefore be configured to capture images of the surrounding environment and provide the resulting image data to the detection module 26 for analysis. In one example, the detection module 26 is configured to detect objects and their locations in the image data and recognize those objects as being the wireless phone 12a, the landline phone 12b, and so forth. Additionally, the detection module 26 may use the cameras 28 to detect visual conditions such as the gaze and/or gestures of a user of the computing device 12c. Thus, it might be determined that the user is looking in the direction of the wireless phone 12a based on the angle of the user's head, the focal point of the users eyes, etc., relative to the information indicating where the wireless phone 12a is located.

Similarly, it may be determined that the user is pointing in the direction of the landline phone 12b based on the position of the user's finger, the position of the user's hand, etc., relative to the information indicating where the landline phone 12b is located. Moreover, a call management module 30 may include a VOIP component 32 that enables routing of calls between the computing device 12c and other devices such as the wireless phone 12a and the landline phone 12b, based on the visual conditions detected with respect to the user of the computing device 12c.

For example, the VOIP component 32 may instruct a VOIP component 34 of the wireless phone 12a and the VOIP switch 20 to route incoming calls to the computing device 12c in response to a detected visual condition indicating a desire of the user to have the calls routed in that fashion. In such a case, a cellular module 40 of the wireless phone 12a may communicate with the cellular network 18 and the VOIP component 34 to facilitate the call transfer, which may involve parsing information, constructing data packets, and so forth.

The VOIP component 32 may also instruct a VOIP component 38 of the landline phone 12b to route incoming calls to the computing device 12c in response to detected visual conditions. Thus, a PSTN module 42 of the landline phone 12b may be configured to function as an interface between the PSTN 24 and the VOIP component 38 in order to facilitate the call transfer through the VOIP switch 20. The communications between the call management module 30 and the VOIP components 32, 38 may be direct or indirect via, for example, the VOIP switch 20. Additionally, the wireless phone 12a and the computing device 12c may communicate directly with the gateway 46 via, for example, a Wi-Fi (Wireless Fidelity, e.g., Institute of Electrical and Electronics Engineers/IEEE 802.11-2007, Wireless Local Area Network/LAN Medium Access Control (MAC) and Physical Layer (PHY) Specifications) link to the Internet 44. In such a case, Internet-based call switching and/or routing may involve the Wi-Fi link. The illustrated VOIP switch 20 is also coupled to the Internet 44 via the gateway 46.

FIG. 2B shows a multi-device architecture in which calls are re-routed to and from the wireless phone 12a based on visual clues. In the illustrated example, the user has connected the headset 14 to a headset module 48 of the wireless phone 12a (e.g., in order to listen to music, watch a video, place and receive cellular calls, etc.). In response to a visual condition detected by the detection module 26 with respect to the user, a first call path 50 may be established, wherein the first call path 50 re-routes incoming VOIP calls to the wireless phone 12a. More particularly, the call management module 30 may instruct the VOIP component 34 of the wireless phone 12a and the VOIP switch 20 to set up the first call path 50. Thus, instead of being directed along a default path 52 to the computing device 12c, the re-routed calls are directed to the VOIP component 34 of the wireless phone 12a, so that the user may continue to operate the wireless phone 12a without any need to manually reach for, pick up, unlock, answer or otherwise operate the computing device 12c. The first call path 50 may also be used to originate outgoing calls from the wireless phone 12a to the Internet 44.

Moreover, if the detected visual condition indicates that the user would like to conduct incoming or outgoing calls via the landline phone 12b, a second call path 54 may be established between the VOIP component 34 of the wireless phone 12a, the VOIP switch 20, the VOIP component 38 of the landline phone 12b, the PSTN module 42 of the landline phone 12b and the PSTN 24. In such a case, an incoming call from the PSTN 24 would be routed to the headset 14 via the headset module 48, and an outgoing call may be placed from the wireless phone 12a to the PSTN 24, wherein user manipulation of the landline phone 12b may be unnecessary in either scenario.

Turning now to FIG. 3, a method 56 of re-routing incoming calls is shown. The method 56 may be implemented as a set of logic instructions and/or firmware stored in a machine- or computer-readable medium such as random access memory (RAM), read only memory (ROM), programmable ROM (PROM), flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof. For example, computer program code to carry out operations shown in the method 56 may be written in any combination of one or more programming languages, including an object oriented programming language such as C++ or the like and conventional procedural programming languages, such as the “C” programming language or similar programming languages. Moreover, the method 56 may be implemented using any of the aforementioned circuit technologies.

Illustrated processing block 57 identifies a plurality of devices within proximity of a user. The identification at block 57 may involve the use of environmental image data corresponding to the surrounding area. The devices may include, for example, wireless phones (e.g., smartphones), landline phones, computing devices (e.g., notebook computers, desktop computers), and so forth. An incoming call may be detected at block 58, wherein detection of the incoming call may be based on a sound signal associated with the surrounding/ambient environment (e.g., microphone signal), a notification signal from the device receiving the call, etc., or any combination thereof. In the case of the use of an ambient sound signal, block 58 may involve comparing the sound signal to ringtone information associated with the nearby devices. For example, each device might be configured with a different ringtone, wherein block 58 may determine whether the measured sound signal matches any of the ringtones. If a match is found, illustrated block 60 identifies the other device associated with the incoming call.

Block 62 may determine whether a visual condition is detected with respect to a user of a device relative to the other device associated with the incoming call. The visual condition may be a gaze of the user in the direction of the other device, a gesture of the user towards the other device, etc., as already discussed. If the visual condition is detected, illustrated block 64 instructs the other device and/or a VOIP switch to re-route the call to the device being operated by the user. The call may be connected to an audio interface of the device being operated by the user at block 66, wherein the audio interface may include a headset module, integrated speaker, external speaker, and so forth.

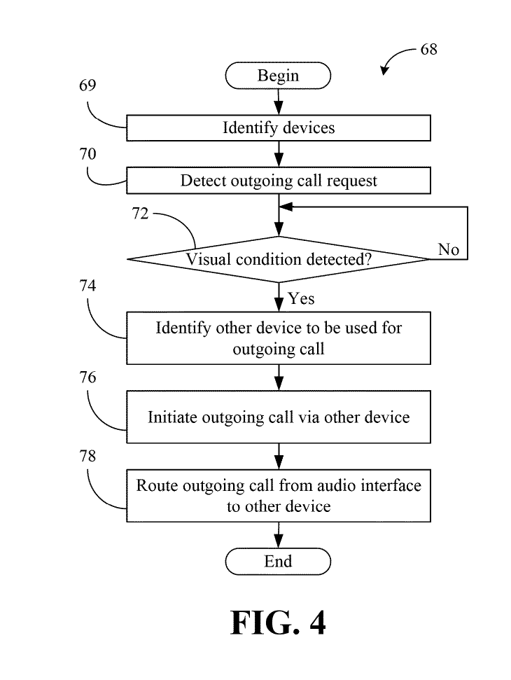

Turning now to FIG. 4, a method 68 of re-routing outgoing calls is shown. The method 68 may be implemented as a set of logic instructions and/or firmware stored in a machine- or computer-readable medium such as RAM, ROM, PROM, flash memory, etc., in configurable logic such as, for example, PLAs, FPGAs, CPLDs, in fixed-functionality logic hardware using circuit technology such as, for example, ASIC, CMOS or TTL technology, or any combination thereof. Illustrated processing block 69 provides for identifying a plurality of devices. The identification at block 69 may involve the use of environmental image data corresponding to the surrounding area, wherein the devices may include, for example, wireless smartphones, landline phones, computing devices (e.g., notebook computers, smart tablets, desktop computers), and so forth. An outgoing call request may be detected at block 70, wherein the outgoing call request may be detected based on a visual condition with respect to a user of a device (e.g., predefined call request gesture) and/or user input such as a selection of a menu option or entry of a command.

A determination may be made at block 72 as to whether a visual condition has been detected with respect to one or more of the plurality of devices. Block 74 may identify a device other than the device being operated by the user based on the visual condition, wherein the other device is to be used to place an outgoing call. Thus, the visual condition might be a glance or gesture in the direction of one of the other devices on the part of the user. An outgoing call may be initiated at block 76 via the other device. Illustrated block 78 routes the outgoing call from an audio interface of the device being operated by the user to the other device making the call.

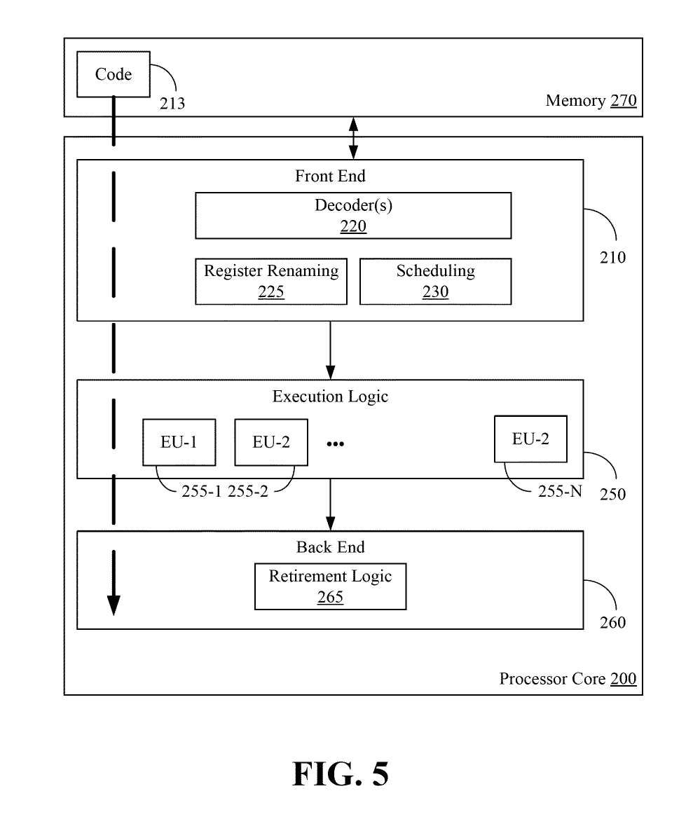

FIG. 5 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 5, a processing element may alternatively include more than one of the processor core 200 illustrated in FIG. 5. The processor core 200 may be a single-threaded core or, for at least one embodiment, the processor core 200 may be multithreaded in that it may include more than one hardware thread context (or “logical processor”) per core.

FIG. 5 also illustrates a memory 270 coupled to the processor 200. The memory 270 may be any of a wide variety of memories (including various layers of memory hierarchy) as are known or otherwise available to those of skill in the art. The memory 270 may include one or more code 213 instruction(s) to be executed by the processor 200 core, wherein the code 213 may implement the method 56 (FIG. 3) and/or the method 68 (FIG. 4), already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end 210 also includes register renaming logic 225 and scheduling logic 230, which generally allocate resources and queue the operation corresponding to the convert instruction for execution.

The processor 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 5, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

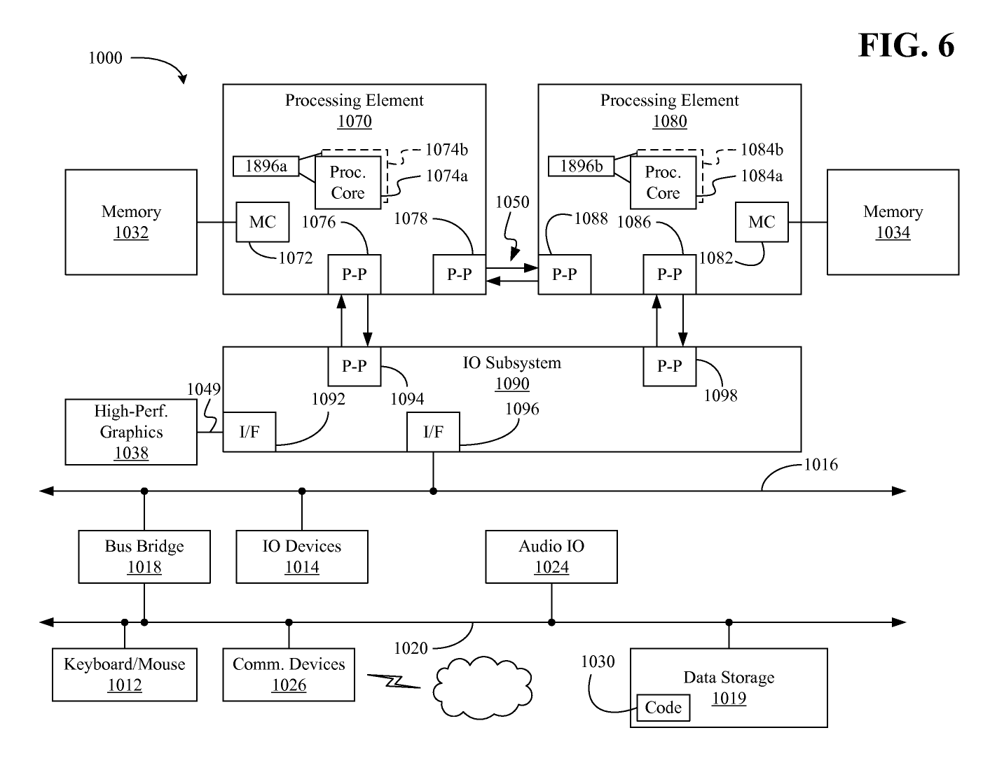

Referring now to FIG. 6, shown is a block diagram of a system 1000 embodiment in accordance with an embodiment. Shown in FIG. 6 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 6 may be implemented as a multi-drop bus rather than point-to-point interconnect.

As shown in FIG. 6, each of processing elements 1070 and 1080 may be multicore processors, including first and second processor cores (i.e., processor cores 1074a and 1074b and processor cores 1084a and 1084b). Such cores 1074, 1074b, 1084a, 1084b may be configured to execute instruction code in a manner similar to that discussed above in connection with FIG. 5.

Each processing element 1070, 1080 may include at least one shared cache 1896. The shared cache 1896a, 1896b may store data (e.g., instructions) that are utilized by one or more components of the processor, such as the cores 1074a, 1074b and 1084a, 1084b, respectively. For example, the shared cache may locally cache data stored in a memory 1032, 1034 for faster access by components of the processor. In one or more embodiments, the shared cache may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 6, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 6, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 6, various I/O devices 1014 (e.g., cameras) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, network controllers/communication device(s) 1026 (which may in turn be in communication with a computer network), and a data storage unit 1019 such as a disk drive or other mass storage device which may include code 1030, in one embodiment. In one example, VOIP calls are conducted via the communication devices 1026. The code 1030 may include instructions for performing embodiments of one or more of the methods described above. Thus, the illustrated code 1030 may implement the method 56 (FIG. 3) and/or the method 68 (FIG. 4), and may be similar to the code 213 (FIG. 5), already discussed. Further, an audio I/O 1024 may be coupled to second bus 1020, wherein the audio I/O 1024 may be used to establish a headset connection.

Note that other embodiments are contemplated. For example, instead of the point-to-point architecture of FIG. 6, a system may implement a multi-drop bus or another such communication topology. Also, the elements of FIG. 6 may alternatively be partitioned using more or fewer integrated chips than shown in FIG. 6.

### Additional Notes and Examples

Example one may include an apparatus to re-route calls, wherein the apparatus has a detection module to identify a plurality of devices. The apparatus may also include a call management module to route a call between a first device in the plurality of devices and a second device in the plurality of devices in response to a visual condition with respect to a user of the first device.

Additionally, the detection module of the apparatus in example one may detect the visual condition based on image data associated with a surrounding environment.

Additionally, the visual condition of the apparatus of example one may be one or more of a gaze of the user and a gesture of the user.

Moreover, the apparatus of example one may further include a headset module to identify a headset connection to the first device, wherein the call management module is to detect an incoming call associated with the second device, instruct one or more of the second device and a voice over Internet protocol (VOIP) switch to route the incoming call to the first device, and connect the incoming call to the headset.

In addition, the incoming call of example one may be detected based on a sound signal associated with a surrounding environment.

In addition, the call management module of example one may compare the sound signal to ringtone information associated with the second device.

Moreover, the incoming call of example one may be detected based on a notification signal from the second device.

Additionally, the apparatus of example one may further include a headset module to identify a headset connection to the first device, wherein the call management module is to detect an outgoing call request based on one or more of the visual condition and user input, initiate an outgoing call via the second device in response to the outgoing call request, and route the outgoing call from the headset to the second device.

Example two may comprise a method including identifying a plurality of devices, and routing a call between a first device in the plurality of devices and a second device in the plurality of devices in response to a visual condition with respect to a user of the first device.

Additionally, the method of example two may further include detecting the visual condition based on image data associated with a surrounding environment.

Additionally, the visual condition in the method of example two may be one or more of a gaze of the user and a gesture of the user.

Moreover, routing the call in the method of example two may include identifying a headset connection to the first device, detecting an incoming call associated with the second device, instructing one or more of the second device and a voice over Internet protocol (VOIP) switch to route the incoming call to the first device, and connecting the incoming call to the headset.

In addition, the incoming call in the method of example two may be detected based on a sound signal associated with a surrounding environment.

In addition, the method of example two may further include comparing the sound signal to ringtone information associated with the second device.

Moreover, the incoming call in the method of example two may be detected based on a notification signal from the second device.

Additionally, routing the call in the method of example two may include identifying a headset connection to the first device, detecting an outgoing call request based on one or more of the visual condition and user input, initiating an outgoing call via the second device in response to the outgoing call request, and routing the outgoing call from the headset to the second device.

Example three may include at least one computer readable storage medium having a set of instructions which, if executed by a first device in a plurality of devices, cause the first device to perform the method of example two.

Example four may include an apparatus to re-route calls, wherein the apparatus has means for performing the method of example two.

Techniques described herein may therefore provide for phone call routing on demand and using gesture identification, gaze tracking and other perceptual computing techniques and modalities. As a result, the user experience may be significantly enhanced even in settings where many different communication devices are within proximity of the user.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Embodiments are applicable for use with all types of semiconductor integrated circuit (“IC”) chips. Examples of these IC chips include but are not limited to processors, controllers, chipset components, programmable logic arrays (PLAs), memory chips, network chips, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size may be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

Some embodiments may be implemented, for example, using a machine or tangible computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. An apparatus comprising:
a detection module to identify a plurality of devices; and
a call management module to route a call between a first device in the plurality of devices and a second device in the plurality of devices in response to a visual condition with respect to a user of the first device.

2. The apparatus of claim 1, wherein the detection module is to detect the visual condition based on image data associated with a surrounding environment.

3. The apparatus of claim 1, wherein the visual condition is to be one or more of a gaze of the user and a gesture of the user.

4. The apparatus of claim 1, further including a headset module to identify a headset connection to the first device, wherein the call management module is to detect an incoming call associated with the second device, instruct one or more of the second device and a voice over Internet protocol (VOIP) switch to route the incoming call to the first device, and connect the incoming call to the headset.

5. The apparatus of claim 4, wherein the incoming call is to be detected based on a sound signal associated with a surrounding environment.

6. The apparatus of claim 5, wherein the call management module is to compare the sound signal to ringtone information associated with the second device.

7. The apparatus of claim 4, wherein the incoming call is to be detected based on a notification signal from the second device.

8. The apparatus of claim 1, further including a headset module to identify a headset connection to the first device, wherein the call management module is to detect an outgoing call request based on one or more of the visual condition and user input, initiate an outgoing call via the second device in response to the outgoing call request, and route the outgoing call from the headset to the second device.

9. At least one computer readable storage medium comprising a set of instructions which, if executed by a first device in a plurality of devices, cause the first device to:
identify the plurality of devices; and
route a call between the first device and a second device in the plurality of devices in response to a visual condition with respect to a user of the first device.

10. The at least one medium of claim 9, wherein the instructions, if executed, cause the first device to detect the visual condition based on image data associated with a surrounding environment.

11. The at least one medium of claim 9, wherein the visual condition is to be one or more of a gaze of the user and a gesture of the user.

12. The at least one medium of claim 9, wherein the instructions, if executed, cause the first device to:
identify a headset connection to the first device;
detect an incoming call associated with the second device;
instruct one or more of the second device and a voice over Internet protocol (VOIP) switch to route the incoming call to the first device; and
connect the incoming call to the headset.

13. The at least one medium of claim 12, wherein the incoming call is to be detected based on a sound signal associated with a surrounding environment.

14. The at least one medium of claim 13, wherein the instructions, if executed, cause the first device to compare the sound signal to ringtone information associated with the second device.

15. The at least one medium of claim 12, wherein the incoming call is to be detected based on a notification signal from the second device.

16. The at least one medium of claim 9, wherein the instructions, if executed, cause the first device to:
identify a headset connection to the first device;
detect an outgoing call request based on one or more of the visual condition and user input;
initiate an outgoing call via the second device in response to the outgoing call request; and
route the outgoing call from the headset to the second device.

17. A method comprising:
identifying a plurality of devices; and
routing a call between a first device in the plurality of devices and a second device in the plurality of devices in response to a visual condition with respect to a user of the first device.

18. The method of claim 17, further including detecting the visual condition based on image data associated with a surrounding environment.

19. The method of claim 17, wherein the visual condition is one or more of a gaze of the user and a gesture of the user.

20. The method of claim 17, wherein routing the call includes:
identifying a headset connection to the first device;
detecting an incoming call associated with the second device;
instructing one or more of the second device and a voice over Internet protocol (VOIP) switch to route the incoming call to the first device; and
connecting the incoming call to the headset.

21. The method of claim 20, wherein the incoming call is detected based on a sound signal associated with a surrounding environment.

22. The method of claim 21, further including comparing the sound signal to ringtone information associated with the second device.

23. The method of claim 20, wherein the incoming call is detected based on a notification signal from the second device.

24. The method of claim 17, wherein routing the call includes:
identifying a headset connection to the first device;
detecting an outgoing call request based on one or more of the visual condition and user input;
initiating an outgoing call via the second device in response to the outgoing call request; and
routing the outgoing call from the headset to the second device.
